(19) United States
(12) Patent Application Publication
(10) Pub. No.: US 2004/0123313 A1
(43) Pub. Date: Jun. 24, 2004

(54) Method for updating key in DCATV conditional access system

(76) Inventors: Han-Seung Koo, Daejon (KR); Eun-Jung Kwon, Daejon (KR); TaeKyoon Kim, Daejon (KR); O-Hyung Kwon, Daejon (KR); Chieteuk Ahn, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/732,024

(22) Filed: Dec. 9, 2003

(30) Foreign Application Priority Data
Dec. 14, 2002 (KR) 2002-79937

(51) Int. Cl. H04N 7/16; H04N 7/167

(52) U.S. Cl. 725/31; 725/25; 725/30

(57) ABSTRACT

The present invention properly updates a key in various situations in order to secure liability of a service in a conditional access system for a digital cable television service. A method for updating a key in a conditional access system of a digital cable television service includes the step of receiving a request of changing service from a point of deployment (POD) module of subscriber having bidirectional or simplex receiver, changing a service at the head/end and sending an entitlement management message (EMM) having a changed key from the head/end to the point of deployment (POD) module.

### FIELD OF THE INVENTION

The present invention relates to a method for updating a key in a conditional access system of a digital cable television service; and, more particularly, to a method for updating a key by sending an entitlement management message (EMM) from a head/end to a subscriber's receiver through out-of-band in a conditional access system of a digital cable television service, and a computer readable recording medium for executing the same method.

### DESCRIPTION OF THE PRIOR ART

A conditional access system of a digital cable television service includes a head/end and a point of deployment (POD) module. The head/end is located at a service provider and provides additional information such as broadcast contents and user management information. The POD module manages conditional access information received from service providers and subscriber information received from subscribers.

A key update is necessary in the conditional access system of the digital cable television service in following cases.

First, a key must be updated periodically for key security.

Second, a key must be updated when the key has a critical problem.

Third, a key must be deleted when the subscription is not valid.

Forth, a key must be added or deleted when the user subscribes a new service or unsubscribes a previous service.

DigiPass, one of the prior conditional access systems, has only the method of periodic update. DigiPass has three problems as follows.

First, when the key has a critical problem, DigiPass does not provide a method for updating the problematic key with a new key.

Second, the key cannot be deleted when an unauthorized subscriber is using the service. For example, when an unauthorized subscriber removes a POD module for a long time and entitlement management messages cannot be delivered, an entitlement of the service cannot be deleted.

Third, a user cannot subscribe a new service or unsubscribe a previous service through a bidirectional receiver of subscriber.

Liability is very important in a digital cable television service. Therefore, various methods are necessary for liability of the digital cable television service.

Liability of a service must be satisfied although a subscriber is not receiving the key update information or avoiding key update on purpose. However, it is not efficient to unlimitedly send key update messages for liability of the service.

### SUMMARY OF THE INVENTION

It is, therefore, a primary object of the present invention to provide a method for properly updating a key in various situations in order to secure liability of a service in a conditional access system for a digital cable television service and a computer readable recording medium for executing the same method.

In accordance with one aspect of the present invention, there is provided a system for providing advertisement to a method for updating a key in a conditional access system having a simplex receiver of a digital cable television service, including the steps of: a) at a head/end, periodically updating a key based upon update information, saving the updated information and sending an EMM having the updated key from the head/end to the POD module of a simplex receiver of subscriber; b) at a head/end, aperiodically updating a key by broadcasting an EMM having a date of key update to the POD module of the subscriber until the subscriber confirms the key update when key update is required and sending EMM having a new key and expiration data to the POD module; and c) at a head/end, coercively updating a key by finding an unauthorized subscriber and sending EMM having a deleted key to a PON module by determining key deletion of the unauthorized subscriber.

In accordance with another aspect of the present invention, there is provided a method for updating a key in a conditional access system having a bidirectional receiver of a digital cable television service, including the steps of: a) periodically updating a key by receiving an operation message from a POD module of a subscriber and sending EMM having an updated key to the POD module at the head/end; b) aperiodically updating a key by receiving an operation message from a POD module of a subscriber and sending EMM having an updated key to the POD module at the head/end; and c) coercively updating a key by at finding an unauthorized subscriber, receiving an operation message from a POD module of the unauthorized subscriber and sending EMM having a deleted key to the POD module the head/end.

In accordance with another aspect of the present invention, there is provided a method for subscribing or unsubscribing a digital cable television service using a conditional access system having a bidirectional receiver, including the steps of: a) at a head/end, receiving a request for subscribing or unsubscribing a digital cable television service from a POD module of a subscriber; b) at the head/end, changing key information of the subscriber and sending an EMM having a changed key information; and c) at the head/end, receiving a confirmation message of subscription or un-subscription from the POD module.

### BRIEF DESCRIPTION OF THE DRAWINGS

The above and other objects and features of the instant invention will become apparent from the following description of preferred embodiments taken in conjunction with the accompanying drawings, in which:

FIG. 1 is a flowchart showing a method for updating a key in a conditional access system of a digital cable television service in accordance with a preferred embodiment of the present invention;

FIGS. 2A and 2B are flowcharts illustrating a method for updating a key periodically in a conditional access system having a simplex receiver of a digital cable television service in accordance with a preferred embodiment of the present invention;

FIG. 3 is a flowchart depicting a method for updating a key periodically in a conditional access system having a bidirectional receiver of a digital cable television service in accordance with a preferred embodiment of the present invention;

FIG. 4 is a flowchart showing a method for updating a key aperiodically in a conditional access system having a simplex receiver of a digital cable television service in accordance with a preferred embodiment of the present invention;

FIG. 5 is a flowchart illustrating a method for updating a key aperiodically in a conditional access system having a bidirectional receiver of a digital cable television service in accordance with a preferred embodiment of the present invention;

FIG. 6 is a flowchart depicting a method for updating a key coercively in a conditional access system having a simplex receiver of a digital cable television service in accordance with a preferred embodiment of the present invention;

FIG. 7 is a flowchart showing a method for updating a key coercively in a conditional access system having a bidirectional receiver of a digital cable television service in accordance with a preferred embodiment of the present invention; and

FIG. 8 is a flowchart showing a method for subscribing or unsubscribing a digital cable television service using a conditional access system having a bidirectional transceiver in accordance with a preferred embodiment of the present invention.

### DETAILED DESCRIPTION OF THE PREFERRED EMBODIMENTS

Hereinafter, preferred embodiments of the present invention will be described in detail with reference to the accompanying drawings.

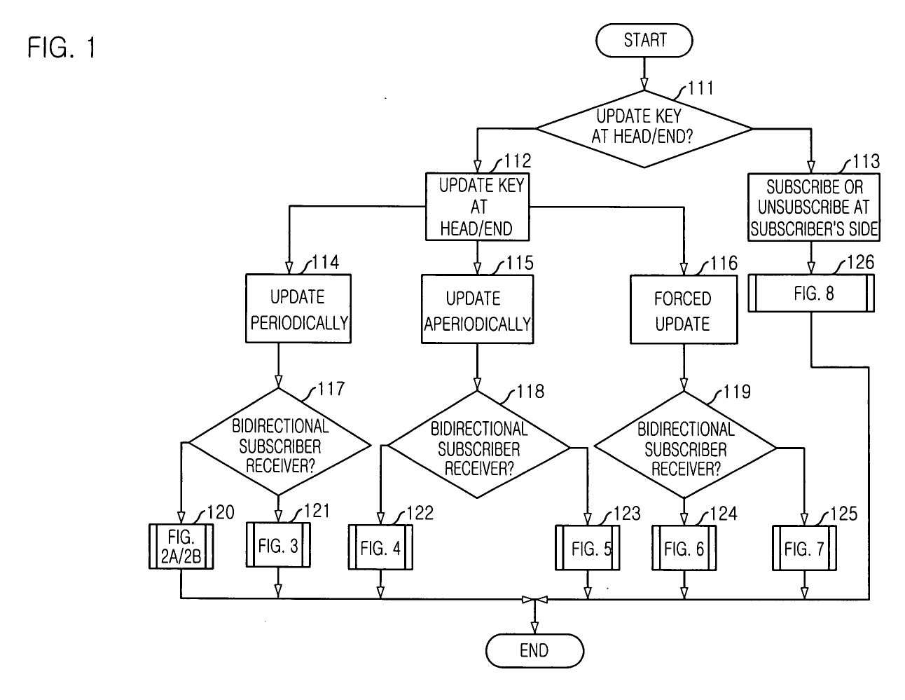

FIG. 1 is a flowchart showing a method for updating a key in a conditional access system of a digital cable television service in accordance with a preferred embodiment of the present invention.

At step S111, it is determined whether to perform an operation of key update at a head/end. A key updating method is divided into two categories. One is a key update in a head/end at step S112 and the other is a key update performed for a subscriber's request for subscribing or unsubscribing of specific service group at step S113.

At step S112, a key update in a head/end is divided into three cases. One is a periodic update at step S114, another is an a periodic update at step S115, and the third is a coercive update at step S116.

At step S114, the periodic update is divided into a key update for a simplex receiver of a subscriber at step S120, and a key update for a bidirectional receiver of a subscriber at step S121. The simplex receiver of the subscriber is a set top box that does not provide a return channel. The return channel is a channel which a subscriber can transmit data to a head/end through.

At step S115, the a periodic update is divided into a key update for a simplex receiver of a subscriber at step S122, and a key update for a bidirectional receiver of a subscriber at step S123. Also, at step S116, a coercive update is divided into a key update for a simplex receiver of a subscriber at step S122, and a key update for a bidirectional receiver of a subscriber at step S123. At step S113, the bidirectional receiver of the subscriber is necessary in case of a key update for subscribing and unsubscribing of a specific service group.

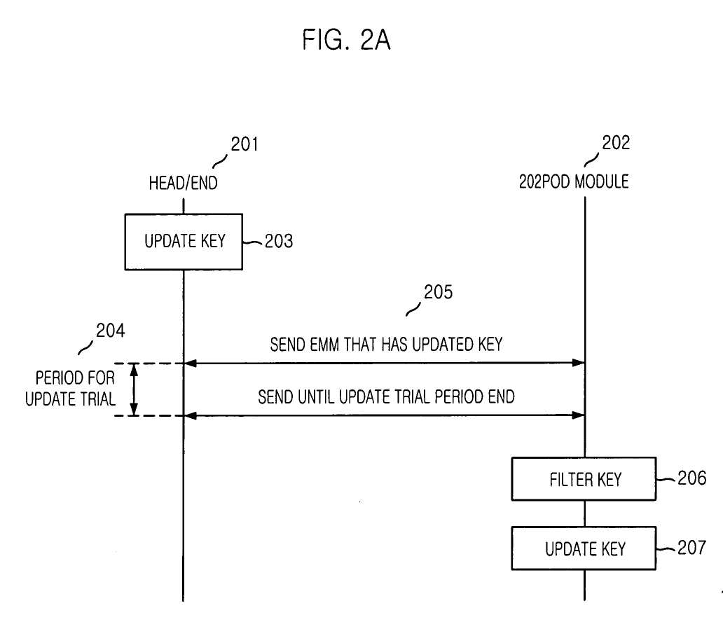

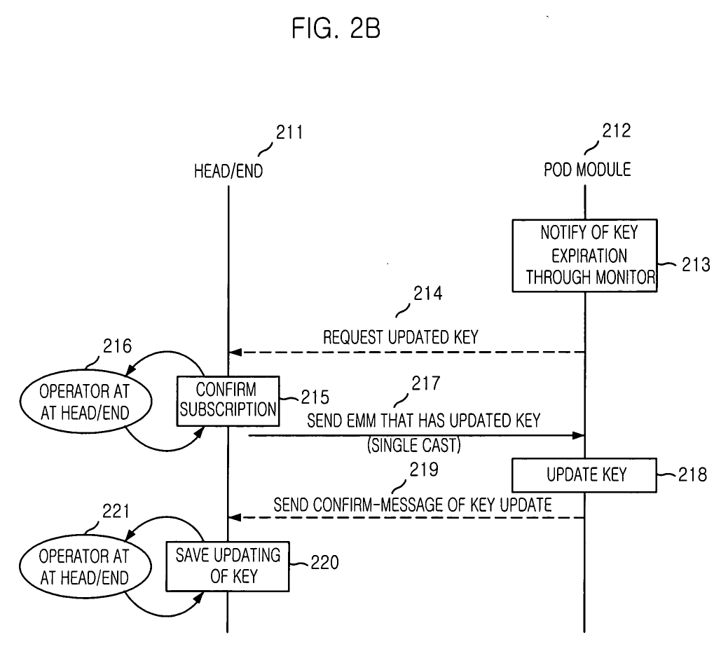

FIGS. 2A and 2B are flowcharts illustrating a method for updating a key periodically in a conditional access system having a simplex receiver of a digital cable television service in accordance with a preferred embodiment of the present invention.

An entitlement management message (EMM) is used to deliver key updating information of a conditional access module from a subscriber to a head/end. The EMM is divided into two kinds: EMMa for periodic delivery and EMMb for a periodic delivery.

EMMa is used for an a periodic key update in a head/end of a simplex receiver of the subscriber. EMMb is used for the other cases of key update.

EMMa is used for aperiodic key update in the simplex receiver of the subscriber because EMMa is broadcasted at a frequent period. EMMb does not have a fixed period. Because EMMa is delivered on demand, EMMa is not adequate for aperiodic key update.

FIGS. 2A and 2B are flowcharts showing a method for updating a key periodically for security in a simplex receiver of a subscriber.

At step S203, a key is updated periodically at a head/end 201. At step S205, the head/end sends an EMM having updated key. The head/end 201 sends the EMM repeatedly to a POD module 202 until a predetermined update period ends. The update period is different according to service providers, for example, when 00 AM, 1^{st} of February is due of a periodic update, the trial period of update is until 24 PM, 31^{st} of January.

At step S204, when the POD module 202 is connected to the head/end 201, the POD module 202 receives the EMM at step S205. Subsequently, the key is filtered at step S206 and updated at step S207.

Referring to FIG. 2B, however, when a POD module 212 is taken apart from the receiver of the subscriber and is not connected to a head/end 211, key expiration is notified through a monitor of the subscriber at step S213. The subscriber requests updating of a key through communication channel such as a telephone or the Internet at step S214.

At step S215, the operator of the conditional access system in digital cable broadcasting network authorizes the subscription of the subscriber. At step S217, the head/end 211 sends an EMM having updated key to the POD module 212. In the mean time, the POD module 212 must be connected and working properly. At step S218, the key is updated. At step S219, the POD module 212 sends a confirmation message of key update to the head/end 211.

In the present invention, the POD module of a simplex receiver can request key update of a digital cable television service to the operator through the telephone network or the Internet network. The POD module 212 must be connected to the head/end 211 during updating of the key. Then, at step S220, the updated key is saved in the head/end 211 of the conditional access system and key updating process is finished.

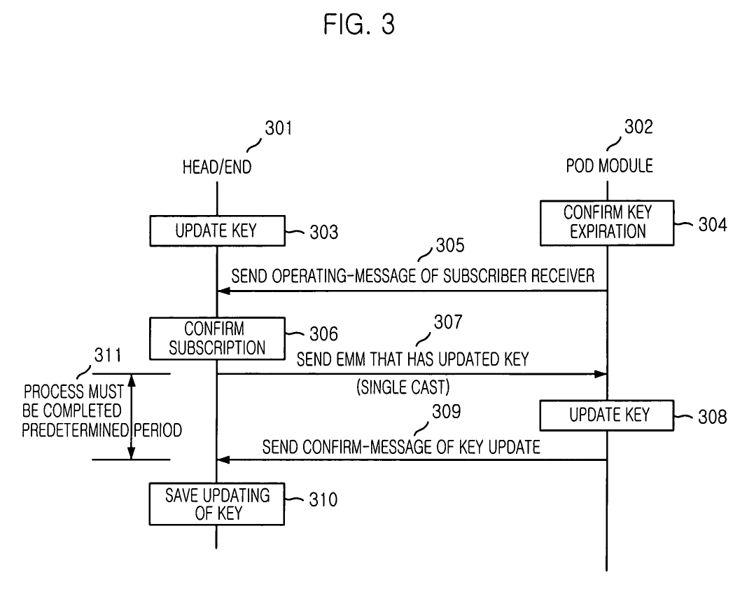

FIG. 3 is a flowchart depicting a method for updating a key periodically in a conditional access system having a bidirectional receiver of a digital cable television service in accordance with a preferred embodiment of the present invention.

At step S303, a head/end 301 updates the key when a key of subscriber is expired. At step S304, key expiration is noticed when a POD module 302 is accessed to the head/end 301. At step S305, the POD module 302 sends an operating message to the head/end 301. At step S306, the subscription is authorized. At step S307, the head/end 301 sends an EMM having an updated key to the POD module 302 of the subscriber. At step S308, the POD module updates the key. At step S309, the POD module 302 sends a confirmation message of key update to the head/end 301. At step S310, the head/end 301 saves the result of the key update.

However, if the confirmation message of key update is not delivered within the predetermined period, the head/end 301 restarts the step S307 by sending the EMM having the updated key information. At step S311, the number of re-trials is predetermined. If a confirmation message of key update is not received within the predetermined trials, a failure of receiving a confirmation message of key update is notified to the operator of the conditional access system. The operator of the conditional access system sends the update failure message to the subscriber by using a communication channel such as wire or wireless phone number, e-mail address, or internet messenger address of the subscriber. The communication channels are saved in subscriber information in the conditional access system.

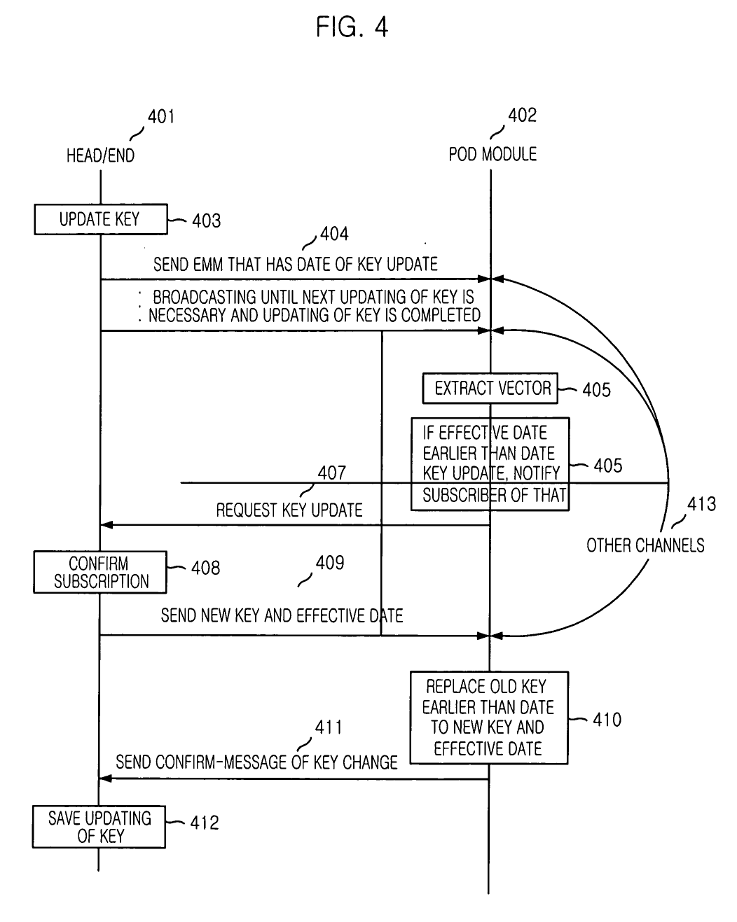

FIG. 4 is a flowchart showing a method for updating a key aperiodically in a conditional access system having a simplex receiver of a digital cable television service in accordance with a preferred embodiment of the present invention.

At step S403, a head/end 401 updates an old key to a new key. The head/end 401 sends the EMM having a key expiration date to a POD module 402 at step S404. The EMMa is used at step S403 and key change date is periodically sent to the POD module 402.

The POD module 402 compares the received expiration date of the key to the old expiration date of the key. At step S406, when the old expiration date is earlier than the new expiration date, the necessity of key update is notified to the subscriber and entitlement is removed from the POD module 402.

At step S407, the subscriber accesses to the operator of the conditional access system and requests a new key to the head/end. At step S408, the subscriber is authorized. At step S409, the head/end 401 sends EMM having a new key and valid date to the POD module 402. When the POD module is not connected to the head/end 401 and not working properly, the operator of the conditional access system sends a subscriber management massage through out-of-band. At step S410, the old key and the old valid date are updated to a new key and a new valid date. At step S410, a new entitlement is given to the subscriber. At step S411, the POD module sends a confirmation message of key change to the operator. At step S412, the head/end 401 saves the updated key.

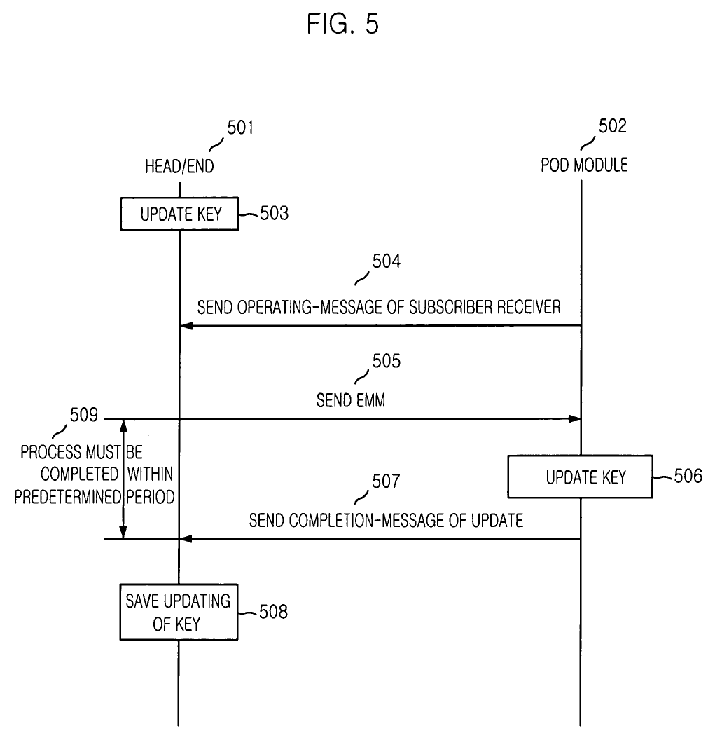

FIG. 5 is a flowchart illustrating a method for updating a key aperiodically in a conditional access system having a bidirectional receiver of a digital cable television service in accordance with a preferred embodiment of the present invention. At step S503, a head/end 501 updates the old key to a new key. At step S504, a POD module sends an operating message of the receiver to the head/end 501. At step S505, the head/end sends an EMM having an updated key to the POD module 502. At step S506, the key is updated. At step S507, the POD module 502 sends a confirmation message of key update to the head/end 501. At step S508, the head/end 501 saves the updated key in the conditional access system. However, if the confirmation message of key update is not received within the predetermined period, the step S505 is restarted. The number of re-trials for sending the EMM is predetermined. If the completion message of key update is not received within the predetermined number of re-trials, the operator of the digital cable broadcasting system sends a key update failure message to the subscriber.

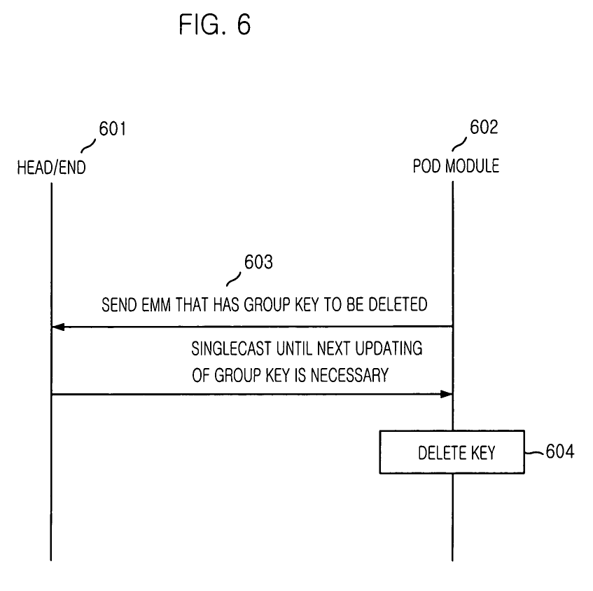

FIG. 6 is a flowchart depicting a method for updating a key coercively in a conditional access system having a simplex receiver of a digital cable television service in accordance with a preferred embodiment of the present invention.

Referring to FIG. 6, a key is coercively deleted because of the delay in paying subscription fee or the other reasons. A head/end 601 finds an unauthorized subscriber and deletes a key of the unauthorized subscriber. At step S603, the head/end 601 periodically sends an EMM having a deleted key to the POD module 502 until the key of the unauthorized subscriber is deleted. At step S604, if the subscriber receives the EMM, the key is deleted. Once the key of the unauthorized subscriber is deleted, the unauthorized subscriber is not provided with the digital cable television service.

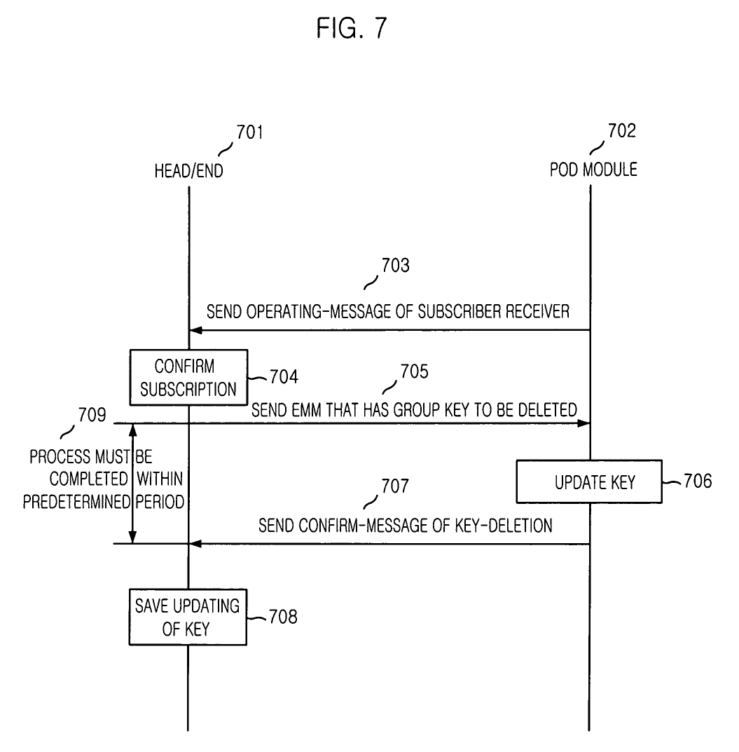

FIG. 7 is a flowchart showing a method for updating a key coercively in a conditional access system having a bidirectional receiver of a digital cable television service in accordance with a preferred embodiment of the present invention.

A head/end 701 finds an unauthorized subscriber and deletes a key of the unauthorized subscriber. At step S703, a POD module 702 sends an operating message of the receiver to the head/end 701. At step S704, subscription is authorized. At step S705, the EMM having a group key to be deleted is periodically sent to the POD module 702 until an update period ends. At step S706, the key is deleted in the POD module 702. At step S707, the POD module sends a confirmation message of key deletion to the head/end 701. At step S708, the head/end 701 saves the key deletion in the conditional access system.

However, if the confirmation message of key deletion is not received within the predetermined period, the step S505 is restarted. The number of re-trials for sending the EMM is predetermined. If the completion message of key deletion is not received within the predetermined number of re-trials, the operator of the digital cable broadcasting system sends a key deletion failure message to the subscriber.

Also, a subscriber can subscribe a new service group or unsubscribe a previous service group.

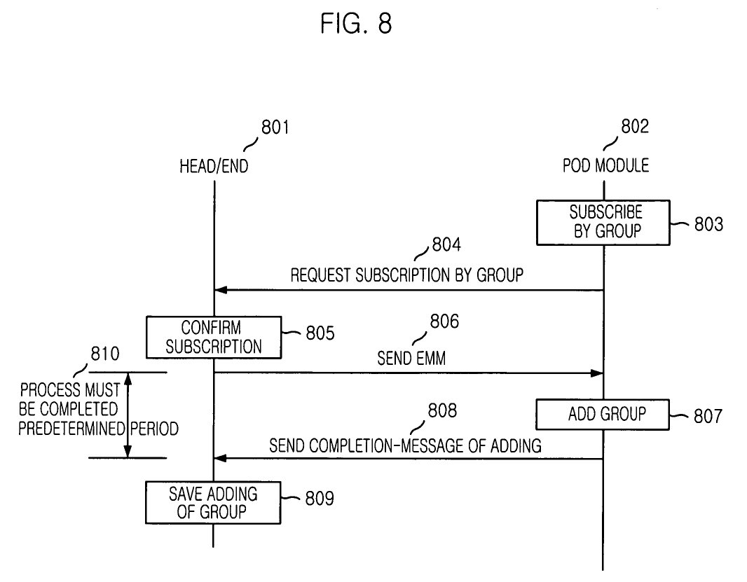

FIG. 8 is a flowchart showing a method for subscribing or unsubscribing a digital cable television service using a conditional access system having a bidirectional transceiver in accordance with a preferred embodiment of the present invention.

At step S804, a POD module 802 requests subscription or un-subscription of a service to a head/end 801. At step S805, the head/end 801 adds or deletes a service group. At step S806, the head/end 801 sends an EMM having a new key or a deleted key to the POD module S802. At step S807, the service group is add or deleted. At step S808, the POD module 802 sends a confirmation message for addition or deletion of the service group to the head/end 801. At step S809, the head/end 801 saves changed information in the conditional access system.

However, if the confirmation message of addition or deletion of the service group is not received, the step S806 is restarted. The number of re-trials for sending the EMM is predetermined. If the completion message of key update is not received within the predetermined number of re-trials, the operator of the digital cable broadcasting system sends a failure message of addition or deletion of the service group to the subscriber.

The method of the present invention can be implemented as a program and stored in a computer readable medium, e.g., a CD-ROM, a RAM, a ROM, a floppy disk, a hard disk, and an optical/magnetic disk.

The present invention can provide liability in updating keys of various situations by using the conditional access system of the digital cable television service.

Also, the present invention can execute updating of keys of a simplex receiver or a bidirectional receiver in the conditional access system of the digital cable television service although the subscriber removed the POD module on purpose.

Although the invention has been shown and described with respect to the preferred embodiments, it will be understood by those skilled in the art that various changes and modifications may be made without departing from the spirit and scope of the invention as defined in the following claims.

What is claimed is:

1. A method for updating a key in a conditional access system having a simplex receiver of a digital cable television service, comprising the steps of:
a) at a head/end, periodically updating a key based upon update information, saving the updated information and sending an EMM having the updated key from the head/end to the POD module of a subscriber;
b) at a head/end, aperiodically updating a key by broadcasting an EMM having a date of key update to the POD module of the subscriber until the subscriber confirms the key update when key update is required and sending EMM having a new key and expiration data to the POD module; and
c) at a head/end, coercively updating a key by finding an unauthorized subscriber and sending EMM having a deleted key to a PON module by determining key deletion of the unauthorized subscriber.

2. The method as recited in claim 1, wherein the step a) updates the key by end of updating period and sends the EMM having the updated key to the POD module until the updating period is over.

3. The method as recited in claim 1, wherein the step a) updates the key when the head/end is notified of an expiration of a key by a subscriber and receives a confirmation message of key updating from the subscriber after sending the EMM having the update key.

4. The method as recited in claim 1, wherein the step b) includes the steps of:
b-1) receiving a request for updating the key from the subscriber after broadcasting the EMM having the data of key update to the POD module;
b-2) confirming the subscription and updating the key of the subscriber; and
b-3) receiving a confirmation message of the POD module after sending EMM having a new key and expiration data.

5. The method as recited in claim 1, wherein the step c) further comprises the step of, at the POD module, receiving the EMM from the head/end and deleting the key.

6. A method for updating a key in a conditional access system having a bidirectional receiver of a digital cable television service, comprising the steps of:
a) periodically updating a key by receiving an operation message from a POD module of a subscriber and sending EMM having an updated key to the POD module at the head/end;
b) aperiodically updating a key by receiving an operation message from a POD module of a subscriber and sending EMM having an updated key to the POD module at the head/end; and
c) coercively updating a key by at finding an unauthorized subscriber, receiving an operation message from a POD module of the unauthorized subscriber and sending EMM having a deleted key to the POD module the head/end.

7. The method as recited in claim 6, wherein the step a) includes steps of:
a-1) at the POD module, sending the operation message of a subscriber to the head/end in order to notify of key expiration of the subscriber;
a-2) at the head/end, receiving the operation message from the POD module, recognized the key expiration of the subscriber and updating the key of the subscriber; and
a-3) at the head/end, sending the EMM having an updated key to the POD module and receiving a confirmation message of key updating of the subscriber from the POD module.

8. The method as recited in claim 7 step a-3), further including the steps of:
a-3-I) at the head/end, transmitting the EMM having key update information repeatedly; and
a-3-II) at the head/end, when the head/end does not receive the confirmation message of key update from the POD module during the transmission of the EMM which is performed predetermined times, sending an update failure message to the subscriber through a communication channel saved in subscriber information.

9. The method as recited in claim 8, wherein the communication channel includes a wire or a wireless phone number, an e-mail address, or an Internet messenger address of the subscriber.

10. The method as recited in claim 6, wherein the step b) includes the steps of:
b-1) at a head/end, updating the key when key updated is required aperiodically;
b-2) at the head/end, receiving the operation message from the POD module of the subscriber when the POD module of the subscriber is operating; and
b-3) at the head/end, sending EMM having the updated key to the POD module, updating the key in the POD module and receiving the confirmation message from the POD module.

11. The method as recited in claim 6, wherein the step c) includes the steps of:
c-1) at the head/end, determining key deletion of the unauthorized subscriber after finding the unauthorized subscriber;
c-2) at the head/end, receiving the operating message from the POD module of the unauthorized subscriber when the POD module of the subscriber is operating and confirming subscription; and
c-3) at the head/end, sending EMM having the deleted key to the POD module of the unauthorized subscriber and receiving a confirmation message of key deletion from the POD module.

12. A method for subscribing or unsubscribing a digital cable television service using a conditional access system having a bidirectional receiver, comprising the steps of:
a) at a head/end, receiving a request for subscribing or unsubscribing a digital cable television service from a POD module of a subscriber;
b) at the head/end, changing key information of the subscriber and sending an EMM having a changed key information; and
c) at the head/end, receiving a confirmation message of subscription or un-subscription from the POD module.
